(19) United States
(12) Patent Application Publication
(10) Pub. No.: US 2006/0238946 A1
(43) Pub. Date: Oct. 26, 2006

(54) Power tool safety system

(75) Inventor: Thomas Schreckenberger, Gutersloh (DE)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: Steinel Gmbh

(21) Appl. No.: 11/110,358

(22) Filed: Apr. 20, 2005

(51) Int. Cl. H02H 3/00

(52) U.S. Cl. 361/100

(57) ABSTRACT

A device for preventing power devices from operating unattended. The device includes a terminal for connection to power, a power device having an ON/OFF switch for turning the power device either ON or OFF, and a safety circuit located between the terminal and the ON/OFF switch. The safety circuit detects the state of the ON/OFF switch to determine whether or not to allow power to be provided from the terminal to the ON/OFF switch. If the ON/OFF switch is in the OFF position when power is applied to the terminal, the safety circuit allows power to be provided to the ON/OFF switch. If the ON/OFF switch is switched to the ON position when power is applied to the terminal, the safety circuit prevents power from being provided to the ON/OFF switch until the ON/OFF switch is first turned OFF.

### BACKGROUND OF THE INVENTION

The present invention relates generally to safety features for use in power tools, and more specifically to a system that prevents power from being supplied to the power tool upon connection to a power supply if the ON/OFF switch of the power tool is in the ON position.

One potentially dangerous and costly hazard in the workplace is the accidental operation of unsupervised power tools. A common scenario involves power tools that are disconnected from an outlet (typically ac power outlet) while an ON/OFF switch or power switch is left in the ON position. Unaware that the ON/OFF switch is in the ON position, an operator connects or plugs the power tool into the outlet. In many instances, the outlet is located far from the power device itself, and connects by a long extension cord. In this scenario, when the operator connects the power tool to the outlet, the power tool will operate unsupervised. This can be hazardous to people near the power tool as well as costly if the unsupervised device causes significant damage. Many other situations exist in which it is critical that power tools or devices not start-up unmonitored.

Another problem is the intentional bypassing of safety systems employed to prevent accidental startup of unmonitored equipment. In many instances, a manual reset button or circuit breaker device is employed, which can be bypassed by methods as simple as placing a piece of tape over the reset button such that it is always in the reset or down position.

### BRIEF SUMMARY OF THE INVENTION

The present invention relates to a device that prevents the inadvertent or unsupervised operation of power tools. The power tool includes an ON/OFF switch and a load. A safety circuit is located between an outlet that connects to a power supply and the ON/OFF switch of the power tool. The safety circuit senses the state of the ON/OFF switch, and if the ON/OFF switch is in the OFF position when connected to power, the safety circuit supplies power from the input terminal to the ON/OFF switch. However, if the ON/OFF switch is in the ON position when connected to power, the safety circuit prevents power from being delivered from the input terminal to the ON/OFF switch until the ON/OFF switch is first turned OFF.

### BRIEF DESCRIPTION OF THE DRAWINGS

FIG. 1 is a diagram of an exemplary embodiment of the present invention including a power device and a power control device.

FIG. 2 is a circuit diagram of the power control device.

### DETAILED DESCRIPTION

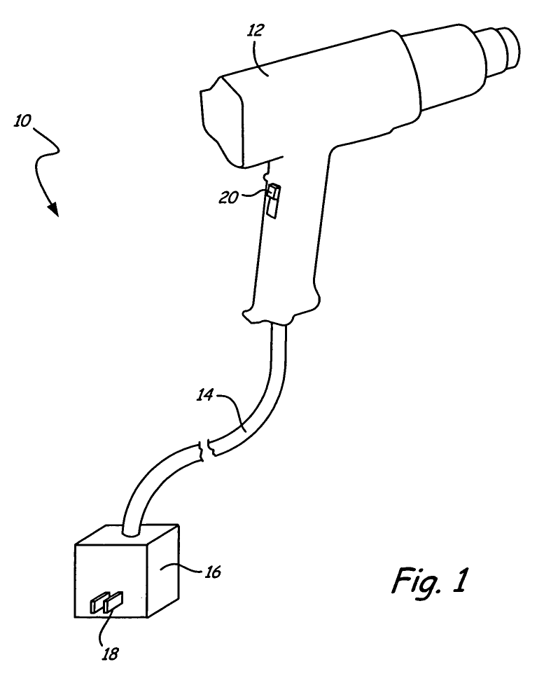

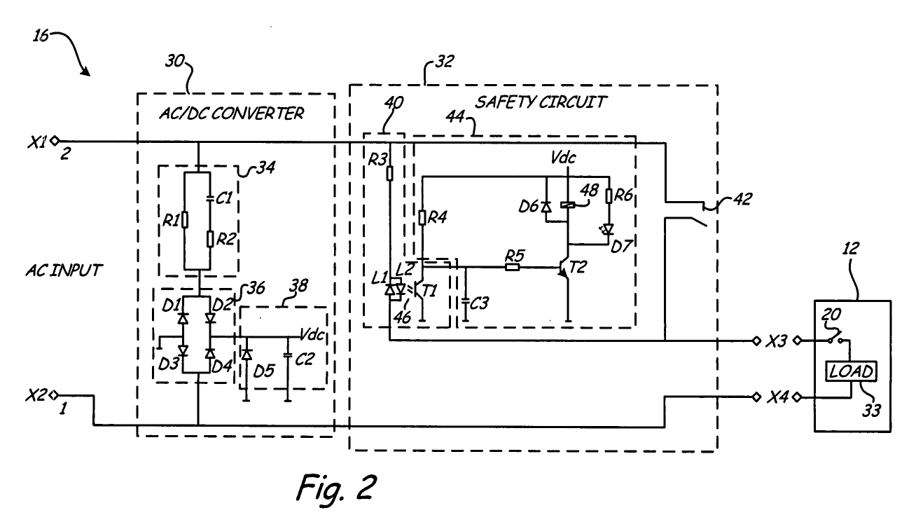

FIG. 1 is an diagram illustrating an exemplary embodiment of safety system 10 of the present invention. Safety system 10 includes a power tool implement 12, shown here as a heat gun, power cord 14, power control device 16 and power plug 18. Power plug 18 connects to an outlet or power supply (not shown), which provides power to power control device 16. Power control device 16, described in more detail in FIG. 2, acts as a gateway between power plug 18 and heat gun 12. ON/OFF switch 20 located on heat gun 12 switches heat gun 12 between two states, ON and OFF. With ON/OFF switch 20 in the ON position, ON/OFF switch 20 is closed, and a current path exists through heat gun 12. If supplied with AC power by power control device 16, heat gun 12 in the ON position generates air flows with temperatures ranging from approximately 50 degrees to over 1000 degrees Fahrenheit. With ON/OFF switch 20 in the OFF position, ON/OFF switch 20 is open, and an open circuit path exists through heat gun 12. Even if AC power is supplied by power control device 16, heat gun 12 will not operate until ON/OFF switch 20 is turned to the ON position. Power control device 16 senses the state of ON/OFF switch 20 and prevents AC power from being supplied to heat gun 12 if ON/OFF switch 20 is ON when AC power is first applied to safety system 10. For instance, in the embodiment of the present invention shown in FIG. 1, power control device 16 prevents AC power from being supplied to ON/OFF switch 20 and thus heat gun 12 in the situation in which ON/OFF switch 20 is in the ON position, and AC power is suddenly supplied to safety system 10. This prevents heat gun 12 from inadvertently operating if unattended. One common scenario in which a typical power tool or heat gun is supplied with AC power while unsupervised occurs when the power tool is unplugged from an outlet while the ON/OFF switch remains in the ON position. Without power, the device no longer operates and an operator may incorrectly believe the ON/OFF switch is in the OFF position. When the operator or some other person travels to the distal end of the power cord to plug back into the outlet, the power tool will be supplied with AC power while unsupervised, resulting in a potentially dangerous condition. In this situation, safety system 10 of the present invention prevents AC power from being supplied to heat gun 12 and thus prevents the inadvertent operation of heat gun 12.

In the exemplary embodiment shown in FIG. 1, power control device 16 and power plug 18 are packaged together, such that an operator cannot disconnect power control device 16 from heat gun 12 in an effort to bypass the safety features of safety system 10. In other embodiments, power control device 16 maybe implemented within heat gun 12, rather than at some distance from heat gun 12 along power cord 14. In yet another embodiment, power control device 16 maybe formed separately from power plug 18, and may be detachable from the power tool implement. This would allow operators to remove power control device 16 from safety system 10 and potentially defeat the safety features of the system, but would also allow the safety circuit to be used with older power tools not equipped with the safety features of the present invention.

FIG. 2 is a circuit diagram of power control device 16, including inputs X1 and X2, outputs X3 and X4, AC/DC converter 30, and safety circuit 32. Inputs X1 and X2 provide AC power from power plug 18 to AC/DC converter 30 and safety circuit 32. Outputs X3 and X4 provide AC power to heat gun 12 if allowed by safety circuit 16. Input X1 is the live input and input X2 is the return or neutral input, likewise, output X3 is the live output and output X4 is the return or neutral output. Heat gun 12 connects to outputs X3 and X4 of power control device 16. To illustrate the operation of power control device 16 in conjunction with heat gun 12, the circuit elements of heat gun 12 are shown. Connected in series between outputs X3 and X4 is ON/OFF switch 20 and AC load 33. ON/OFF switch 20 is connected to output X3, such that power must travel through ON/OFF switch 20 before being applied to AC load 33. AC load 33 may be a motor, heater, or some other element requiring power to do work.

AC/DC converter 30 operates to convert AC power to direct current (DC) power. In the embodiment shown in FIG. 2, AC/DC converter 30 takes as an input AC power provided at input X1, and converts it to 24 volt DC power V_{dc}. AC/DC convert 30 includes voltage divider circuit 34, bridge rectifier 36, and stabilization circuit 38. Voltage divider circuit 34 is connected to input X1 and includes resistors R1 and R2 and capacitor C1. AC power supplied to voltage divider circuit 34 (typically between 110 and 220 volts) is reduced by voltage divider circuit 34 to a lower voltage before being provided to bridge rectifier 36. Bridge rectifier 36 includes diodes D1, D2, D3, and D4, which operate to rectify the AC signal to a DC signal. The output of bridge rectifier 36 is a roughly DC signal that is provided to stabilization circuit 38. Stabilization circuit 38 includes zener diode D5 and capacitor C2. Zener diode D5 ensures the voltage provided by bridge rectifier 36 does not rise above the desired 24 volts, while capacitor C2 helps stabilize the voltage provided by bridge rectifier 36 from falling below the desired 24 volts. AC/DC converter 30 shown in FIG. 2 is an exemplary embodiment, although a person of skill in the art would recognize that there are a number of ways to implement an AC/DC converter. The output of AC/DC converter V_{dc} is supplied to safety circuit 32. In this embodiment, voltage V_{dc} is 24 volts, although a person of ordinary skill in the art would recognize that the present invention is not limited to this voltage. In other embodiments in which power is supplied from a DC power source, an AC/DC converter circuit would not be necessary, but instead a voltage step down circuit or transformer may be required in place of the AC/DC converter circuit.

Safety circuit 32 operates to prevent AC power from reaching heat gun 12 in situations in which ON/OFF switch 20 is ON and AC power is suddenly provided to safety system 10. Safety circuit 32 includes monitoring circuit 40, relay contact 42, and relay control circuit 44. Monitoring circuit 40 is connected to input X1 and output X3, and operates to detect the state of ON/OFF switch 20 based on the resistance between outputs X3 and X4. If ON/OFF switch 20 is OFF (i.e. switch 20 is open), then the resistance between output X3 and X4 is very high. If ON/OFF switch 20 is ON (i.e. switch 20 is closed), then the resistance between outputs X3 and X4 is much lower (approximately equal to the resistance through AC load 33). If ON/OFF switch 20 is ON when AC power is provided to safety circuit 16, then monitoring circuit 40 prevents AC power from being supplied to heat gun 12 via relay contact 42.

Monitoring circuit 40 includes resistor R3 and optocoupler 46, which includes light emitting diodes (LEDs) L1 and L2 and photo-transistor T1. Relay contact 42 is also connected to input X1 and output X3. When closed, relay contact 42 provides a current path between input X1 and output X3, such that AC power provided at input X1 is supplied to heat gun 12. Relay contact 42 is open and closed by relay control circuit 44. Relay control circuit 44 is connected to DC voltage V_{dc} provided by AC/DC converter 30. Relay control circuit 44 includes relay coil 48, resistors R4, R5, and R6, capacitor C3, transistor T2, diode D6 and light emitting diode L3.

When power is applied to safety system 10, there are two possible scenarios. In the first scenario, relay control circuit 44 uses the voltage provided by AC/DC converter 30 to energize relay coil 48 and close relay contact 42. ON/OFF switch 20 is in the OFF position and relay control circuit 44 will close relay contact 42 and allow power to be applied to heat gun 12. When ON/OFF switch 20 is turned to the ON position by an operator, indicating heat gun 12 is attended, then heat gun 12 operates in the typical fashion. In the second scenario, ON/OFF switch 20 is in the ON position when AC power is applied, indicating heat gun 12 may be unattended. In this scenario, monitoring circuit 40 senses that ON/OFF switch 20 is in the ON position and prevents relay control circuit 44 from energizing relay coil 48, preventing the closing of relay contact 42. Heat gun 12 will not operate until ON/OFF switch 20 is first turned to the OFF position. The operation of safety circuit 32 with respect to each scenario is discussed below.

In the first scenario, ON/OFF switch 20 is in the OFF position, resulting in an open circuit condition and creating a large resistance between outputs X3 and X4 as seen by safety circuit 32. The open circuit between outputs X3 and X4 prevents current from flowing through monitoring circuit 40, including resistor R3 and LEDs L1 and L2, to heat gun 12. Similarly, at this time relay contact 42 is open, meaning no current travels from input X1 to output X3 through relay contact 42. Power provided at terminal X1 is supplied to AC/DC converter 30, resulting in the generation of DC voltage V_{dc}. DC voltage V_{dc} is provided to relay control circuit 44 and is connected to relay coil 48, as well as to capacitor C3, causing capacitor C3 to charge. A fully charged capacitor C3 provides sufficient voltage to transistor T2 through resistor R5 such that transistor T2 is turned on. In this embodiment, transistor T2 is being used as a switch having one of two states depending on the voltage supplied to transistor T2 by capacitor C3. In this particular embodiment, transistor T2 is implemented with a bipolar junction transistor (BJT), although a person of skill in the art would recognize that transistor T2 may be implemented in a number of ways. If no voltage or very little voltage is provided by capacitor C3, then transistor T2 is in the first state or off. In the off state, transistor T2 is non-conductive or high resistance, preventing current from flowing through transistor T2. If sufficient voltage is supplied by capacitor C3 then transistor T2 is in the second state or on. In the on state, transistor T2 is conductive or low resistance, and allows current to flow through the transistor. When transistor T2 is on, a current path is created between DC voltage V_{dc}, through relay coil 48 and transistor T2 to ground. Current flowing through relay coil 48 causes relay contact 42 to close, providing a current path between input X1 and output X3 such that power is provided to heat gun 12. At this point in time, ON/OFF switch 20 is in the OFF position (open circuit), and therefore even though AC power is available to heat gun 12, because of the open circuit, no power is provided to AC load 33. Once ON/OFF switch 20 is turned to the ON position (closed circuit), power is provided to AC load 33 and heat gun 12 operates as expected. Diode D6 operates to protect relay coil 48 from unexpected spikes in current, and resistor R6 and LED L3 operate to provide notice to a user that power is being supplied to output terminal X3 such that heat gun 12 is ready for use. When transistor T2 is on, allowing DC voltage V_{dc} to create current through relay coil 48, some current will flow through resistor R6 and LED L3 such that LED L3 emits light indicating to an operator that power is being provided to heat gun 12.

In the second scenario, in which ON/OFF switch 20 is in the ON position (closed circuit), a current path exists through heat gun 12. In this scenario, when AC power is suddenly applied to safety system 10, safety circuit 32 prevents AC power from being supplied to heat gun 12 by preventing relay contact 42 from closing. When ON/OFF switch 20 is in the ON position (closed circuit), a current path exists from input X1, through monitoring circuit 40 and ON/OFF switch 20 to AC load 33. The current through monitoring circuit 40 (and therefore through heat gun 12 via output X3) is kept relatively small by resistor R3, which prevents heat gun 12 from being supplied with power sufficient to operate heat gun 12. Current through LEDs L1 and L2 of optocoupler 46 however is sufficient to excite the light emitting diodes. When the phase of AC current is positive, current will flow through LED L2 and cause light to be emitted. When the phase is negative, current will flow through LED L1 and also cause light to be emitted. In this way, whenever there is current flowing through monitoring circuit 40, light is emitted by either LED L1 or LED L2. If light is emitted from LED L1 or L2, indicating current through monitoring circuit 40, photo-transistor T1 is turned on. As discussed above with respect to transistor T2, photo-transistor T1 is also switched between one of two states based on the signal (light) provided by LEDs L1 and L2. In the first state, if no signal is provided by LEDs L1 and L2, photo-transistor T1 is non-conductive or off. When photo-transistor T1 is off, DC voltage V_{dc} is allowed to charge capacitor C3, which turns on transistor T2. When current flows through LEDs L1 and L2 photo-transistor T1 is turned on, allowing current created by DC voltage V_{dc} to be dissipated through photo-transistor T1 instead of charging capacitor C3. Likewise, capacitor C3 also discharges stored energy through photo-transistor T1 instead of providing power to transistor T2. As long as photo-transistor T1 is on, capacitor C3 is unable to fully charge and therefore cannot turn on transistor T2, which prevents relay contact 42 from closing. In this manner, no current is allowed to flow from input X1 through relay contact 42 to output X3 and heat gun 12.

In order to close relay contact 42 and operate heat gun 12, ON/OFF switch 20 must first be turned to the OFF position, and then back to the ON position. When heat gun 12 is turned to the OFF position, an open circuit is created by ON/OFF switch 20 between output X3 and output X4, such that current no longer flows from AC input X1 through monitoring circuit 40 to output X3. This prevents photo-transistor T1 from turning on, and allows DC voltage V_{dc} to fully charge capacitor C3. A fully charged capacitor C3 results in transistor T2 being turned on and DC voltage V_{dc} generates current through relay coil 48 and transistor T2 to ground, allowing relay contact 42 to close. Thus, if AC power is suddenly supplied to safety system 10 when ON/OFF switch 20 is ON, the only way to operate heat gun 12 is for an operator to switch ON/OFF switch 20 to the OFF position, and then back to the ON position. In this way, safety system 10 ensures that an operator is attending heat gun 12 when power is actually supplied to heat gun 12 or any power device.

Table 1 provides a list of components used to implement the exemplary embodiment of the present invention as shown in FIG. 2. The present invention is not limited to the list of elements or the associated values of the elements.

TABLE 1

| | VALUE or |
|---|---|
| COMPONENT | PART NUMBER |
| Resistor R1 | 220 kΩ |
| Resistor R2 | 560 Ω |
| Resistor R3 | 47 kΩ |
| Resistor R4 | 100 kΩ |
| Resistor R5 | 33 kΩ |
| Resistor R6 | 4.7 kΩ |
| Capacitor C1 | 680 nF |
| Capacitor C2 | 10 μF |
| Capacitor C3 | 1 μF |
| Diode D1 | 1N4007 |
| Diode D2 | 1N4007 |
| Diode D3 | 1N4007 |
| Diode D4 | 1N4007 |
| Zener Diode D5 | 24 V |
| Diode D6 | 1N4007 |
| Light Emitting Diode (LED) L1 | TLHG 4900 |
| Light Emitting Diode (LED) L2 | TLHG 4900 |
| Light Emitting Diode (LED) L3 | TLHG 4900 |
| Photo-Transistor T1 | SFH620a-2 |
| Transistor T2 | BC546B |
| Relay Contact 42 | RP 33SL24 K1 |
| Relay Coil 48 | RP 33SL24 |

Although the present invention has been described with reference to preferred embodiments, workers skilled in the art will recognize that changes may be made in form and detail without departing from the spirit and scope of the invention.

1. A safety power system comprising:
a terminal for connecting to power;
a load within the power tool;
an ON/OFF switch connected to the load wherein the ON/OFF switch prevents power from reaching the load when the ON/OFF switch is in a first state and allows power to reach the load when the ON/OFF switch is in a second state; and
a safety circuit connected between the terminal and the ON/OFF switch for sensing whether the ON/OFF switch is in the first state or the second state and controlling power to the ON/OFF switch depending on the sensed state, wherein if the ON/OFF switch is in the first state when power is supplied to the terminal, the safety circuit supplies power from the terminal to the ON/OFF switch and wherein if the ON/OFF switch is in the second state when power is supplied to the terminal, the safety circuit prevents power from being delivered to the ON/OFF switch until the ON/OFF switch is placed in the first state.

2. The safety power system of claim 1, wherein the safety circuit comprises:
a relay contact located in a first conductive path between the terminal and the ON/OFF switch wherein if the relay is open no power is provided to the ON/OFF switch from the terminal via the first conductive path and if the relay is closed power is provided to the ON/OFF switch from the terminal via the first conductive path;
a monitoring circuit located in a second conductive path between the terminal and the ON/OFF switch wherein if the ON/OFF switch is in the first state no current travels through the second conductive path, but if the ON/OFF switch is in the second state current flows in the second conductive path; and
a relay control circuit wherein if the ON/OFF switch is in the first state the relay control circuit causes the relay contact to close, but if the ON/OFF switch is in the second state, current flowing in the monitoring circuit prevents the relay control circuit from closing the relay contact.

3. The safety power system of claim 2, wherein the relay control circuit comprises:
a power supply;
a relay coil connected to the power supply, wherein current flowing through the relay coil causes the relay contact to close;
a capacitor coupled to the power supply, wherein the power supply provides charge to the capacitor; and
a second switch connected to the relay coil having a first state and a second state determined by the charge provided by the capacitor, wherein if the second switch is in the first state current is prevented from flowing through the relay coil, and wherein if the second switch is in the second state current is allowed to flow through the relay coil, causing the relay contact to close.

4. The safety power system of claim 2, wherein the monitoring circuit comprises:
a resistor connected to the terminal;
a light emitting diode (LED) connected to the resistor that emits light when current flows through the monitoring circuit; and
a third switch connected to the capacitor having a first state and a second state determined by light emitted by the LED, wherein if the LED is not emitting light the third switch is in the first state and allows the relay control circuit to close the relay contact and wherein if the LED is emitting light the third switch is in the second state and prevents the relay control circuit from closing the relay contact.

5. The safety power system of claim 4, wherein the resistor has a resistance of about 47 k ohms.

6. The safety power system of claim 2, wherein if the ON/OFF switch is in the second state, current flowing in the monitoring circuit is insufficient to power the power tool.

7. The safety power system of claim 3, wherein the second switch is a bipolar junction transistor.

8. The safety power system of claim 4, wherein the third switch is a photo-transistor.

9. A power device comprising:
an ON/OFF switch;
a power cord attached to the power device;
a power plug located at the distal end of the power cord, having a terminal for connection to AC power; and
a safety circuit integrated within the power plug electrically located between the terminal and the ON/OFF switch, wherein if the ON/OFF switch is OFF when AC power is supplied to the terminal the safety circuit allows AC power to be provided to the power device, but if the ON/OFF switch is ON when ac power is supplied to the terminal the safety circuit prevents AC power from being provided to the power device until the ON/OFF switch is first switched OFF.

10. The power device of claim 9, the safety circuit comprising:
a relay contact located in a first conductive path between the terminal and the power device wherein if the relay is open no AC power is provided to the power device from the terminal and if the relay is closed AC power is provided to the power device from the terminal;
a monitoring circuit located in a second conductive path between the terminal and the power device wherein if the ON/OFF switch is OFF no current travels along the second conductive path, and wherein if the ON/OFF switch is ON current flows in the second conductive path; and
a relay control circuit wherein if the ON/OFF switch is OFF the relay control circuit causes the relay contact to close, and AC power is provided to the power device, but if the ON/OFF switch is ON, current flowing in the monitoring circuit prevents the relay control circuit from closing the relay contact, and prevents AC power from being supplied to the power device.

11. The power device of claim 10, wherein the relay control circuit comprises:
a DC power supply;
a relay coil connected to the DC power supply, wherein current generated by the DC power supply flowing through the relay coil causes the relay contact to close;
a capacitor coupled to the DC power supply, wherein the DC power supply provides charge to the capacitor; and
a second switch connected to the relay coil having a first state and a second state determined by the charge provided by the capacitor, wherein if the second switch is in the first state it prevents current from flowing through the relay coil and if the second switch is in the second state it allows current to flow in the relay coil, causing the relay contact to close.

12. The power device of claim 11, wherein the DC power supply is provided by an AC/DC converter connected to AC power.

13. The power device of claim 11, wherein the monitoring circuit comprises:
a first resistor connected to the terminal;
a light emitting diode (LED) connected between the first resistor and the ON/OFF switch, wherein the LED emits light when current flows through the monitoring circuit; and
a third switch connected to the capacitor having a first state and a second state determined by the light emitted by the LED, wherein if the third switch is in the first state it allows the relay control circuit to close the relay contact and if the third switch is in the second state it prevents the relay control circuit from closing the relay contact.

14. The power device of claim 13, wherein if the third switch is in the first state, the capacitor is sufficiently charged to place the second switch in the second state, allowing current to flow from the DC power supply, through the relay coil and the second switch, with current in the relay coil causing the relay contacts to close.

15. The power device of claim 13, wherein if the third switch is in the second state, the capacitor discharges through the third switch and does not have sufficient charge to place the second switch in the second state, resulting in no current flowing from the DC power supply, through the relay coil and the second switch, preventing the relay contacts from closing.

16. A safety circuit connected between a terminal and a power device, the safety circuit comprising:
a relay contact located in a first conductive path between the terminal and the power device wherein if the relay is open no power is provided to the power device from the terminal via the relay contact and if the relay is closed power is provided to the power device from the terminal via the relay contact;
a monitoring circuit located in a second conductive path between the terminal and the power device wherein if the power device is OFF no current travels along the second conductive path, but if the power device is ON current flows in the second conductive path; and
a relay control circuit wherein if the power device is OFF when power is provided at the terminal, the relay control circuit causes the relay contact to close, and power is provided to the power device, but if the power device is ON when power is provided at the terminal, current flowing in the monitoring circuit prevents the relay control circuit from closing the relay contact, and prevents power from being supplied to the power device.

17. The safety circuit of claim 16, wherein the relay control circuit comprises:
a DC power supply;
a relay coil connected to the DC power supply, wherein current flowing through the relay coil causes the relay contact to close;
a capacitor coupled to the DC power supply, wherein the DC power supply provides charge to the capacitor; and
a first transistor connected to the relay coil having a conducting state and a non-conducting state determined by the charge provided by the capacitor, wherein if the first transistor is in the non-conducting state it prevents current from flowing through the relay coil and if the first transistor is in the conducting state it allows current to flow in the relay coil, causing the relay contact to close.

18. The safety circuit of claim 17, wherein the monitoring circuit comprises: a resistor connected to the terminal;
a light emitting diode (LED) connected to the first resistor that emits light when current flows through the monitoring circuit; and
a photo-transistor connected to the capacitor having a non-conducting state and a conducting state determined by light generated by the LED, wherein if the photo-transistor is in the first state it allows the relay contact to close, wherein if the photo-transistor is in the second state it prevents the relay contact from closing.

19. The safety circuit of claim 18, wherein if the photo-transistor is in the non-conducting state, the DC power supply charges the capacitor, resulting in the first transistor being in the conducting state and current being generated by the DC power supply, through the relay coil and the first transistor, and closing the relay contact.

20. The safety circuit of claim 18, wherein if the photo-transistor is in the conducting state, the capacitor discharges through the photo-transistor, resulting in the first transistor being in the non-conducting state such that no current flows from the DC power supply, through the relay coil and the first transistor, and the relay contact does not close.
